(19) United States
(12) Patent Application Publication
(10) Pub. No.: US 2006/0051018 A1
(43) Pub. Date: Mar. 9, 2006

(54) Integrated optics component comprising a cladding and method for making same

(75) Inventor: Christophe Martinez, Grenoble (FR)

Correspondence Address: PILLSBURY WINTHROP SHAW PITTMAN, LLP, P.O. BOX 10500, MCLEAN, VA, 22102, US

(73) Assignee: TEEM PHOTONICS, MEYLAN (FR)

(21) Appl. No.: 10/512,997

(22) PCT Filed: May 12, 2003
(86) PCT No.: PCT/FR03/01442

§ 371 Date: Jul. 1, 2005

(30) Foreign Application Priority Data
May 13, 2002 (FR) 02/05842

(51) Int. Cl. G02B 6/42; C03B 37/022; C03C 27/00; G02B 6/26

(52) U.S. Cl. 385/31; 385/37; 385/39; 385/42; 385/43; 385/50; 385/129; 385/130; 385/132; 385/141; 65/386; 65/394

(57) ABSTRACT

This invention relates to an integrated optics component including at least one optical guide core (11) and at least one optical cladding (9) in a substrate (7), the core and the cladding being independent of each other in the substrate, at least one portion of said cladding surrounding at least one portion of said core so as to define at least one so-called interaction area (20) between the core and the cladding, the refraction index of the cladding is different from the refraction index of the substrate and is less than the refraction index of the core at least in the part of the cladding close to the core and at least in the interaction area, a light wave possibly being introduced into said area through the core and/or the cladding. The invention is used for applications particularly in the domain of optical telecommunications, for example to make a spectral or spatial filter or a Mach-Zehnder type interferometer, or a temperature sensor.

### TECHNICAL DOMAIN

This invention relates to an integrated optics component including an optical cladding and its manufacturing method.

The invention is used for applications in all domains requiring a modification of the characteristics of modes propagating in the core of an optical guide and/or excitation of cladding modes and particularly in the domain of optical telecommunications, for example to make a spectral filter or a temperature sensor, in integrated optics.

### STATE OF PRIOR ART

Optical claddings are known essentially in the domain of optical fibres. Optical claddings conventionally surround the fibre core, with a refraction index less than the refraction index of the core, which enables propagation of a light wave in the core of these fibres.

By varying the value of the refraction index of the cladding, the propagation characteristics of the propagation mode(s) in the core of an optical fibre can be varied, and in particular its guidance properties can be optimised and specifically chromatic dispersion can be reduced.

It is also known how to use cladding modes by making these optical claddings with optical fibre gratings in order to couple one or more guided modes in the core of a fibre to the cladding mode(s) of the fibre, or vice versa. For example, further information about this is given in U.S. Pat. No. 5,430,817.

In all cases, the core of the fibre does not enable correct propagation of a light wave without the optical cladding. The cladding and the core are dependent and form the fibre.

FIGS. 1 and 2 diagrammatically illustrate a perspective and sectional view respectively through an example embodiment of an optical cladding used according to prior art, with an optical fibre grating.

Thus, FIG. 1 shows the core 1 of the fibre with refraction index n_{c} in which a light wave is guided, with an optical cladding 2 with index n_{g} for guidance of this light wave by a change of the index to make it different from the index of the core (n_{c}>n_{g}), and a mechanical cladding 3 to protects the assembly. The mechanical cladding has been deliberately partly removed in FIG. 1, to simplify the view.

A grating 6 is made in the core 1 of the fibre, and is represented on the section in FIG. 2 by an alternation of grey and white areas. This grating is formed by the creation of areas (grey areas) in the core with a refraction index greater than the refraction index of the rest of the core (white areas).

This grating provides a means of coupling a guided mode, symbolically represented by a set of concentric circles reference 4, to one or several cladding modes 5 propagating in the optical cladding 2, in the same direction as guided mode 4. Cladding modes are also represented symbolically by sets of concentric circles reference 5.
Coupling between the different modes takes place for wavelengths % j determined by the following known relation:
   λⱼ=Λ×(n₀−nⱼ) (1)
where:
   n₀ is the effective index of the guided mode (4),
   nⱼ is the effective index of cladding mode number j,
   λⱼ is the resonance wavelength for coupling to mode j;
   Λ is the grating period.

In general, there is a small difference between the effective indexes n₀ and nⱼ (from a few 10⁻² to a few 10⁻³) and the wavelength range concerned by optical guidance is about 1.5 μm. Consequently, relation (1) shows that grating periods are frequently of the order of a few tens of μm to a few thousand μm.

For example, this type of component is used as a filter element.

Coupling creates an energy transfer between guided mode 4 and cladding modes 5 for wavelengths λⱼ. Energy coupled in the cladding modes is then dispersed outside the cladding along the propagation of modes in the cladding, such that the light wave recovered at the output from the guide 1 has a power spectrum with energy losses for wavelengths λⱼ on “filter” spectral bands. Furthermore, coupled energy in cladding modes is not reflected by the grating, which isolates the filter in terms of parasite reflections.

In integrated optics, a light wave is conventionally guided in the core of a guide by confining the core in one or more layers of a substrate, these layers having a refraction index less than the refraction index of the core.

Furthermore, U.S. Pat. No. 5,949,934 describes the use of an optical cladding on each side of a grating formed in the core of a guide in integrated optics, this assembly being arranged on a substrate. This cladding is made by superposition of layers between which the core is sandwiched. Therefore in this patent, the core is dependent on the cladding since it cannot exist without the layers between which it is arranged. Thus, the cladding described in this patent induces cladding modes and makes it possible to provide a support for the guide core. Furthermore, since the cladding usually has the same refraction index as a substrate, the cladding is not optically different from the substrate.

Therefore, at the moment there is not any optical cladding associated with an optical guide core in integrated optics or even associated with a fibre core, and independent from this core, and vice versa.

### SUMMARY OF THE INVENTION

The purpose of this invention is to divulge an integrated optics component with at least one optical cladding that is independent from the guide core(s) with which it is associated. Independence of the core and the cladding means that they can exist in a substrate independently of each other.

Another purpose of the invention is to make an integrated optics component with at least one optical cladding associated with at least one optical guide core capable in particular of modifying at least one characteristic of the mode(s) propagating in the core and/or inducing one or more propagation modes in this cladding.

In particular, the characteristics of the mode(s) propagating in the core may be the effective index, the mode size and/or the phase.

More precisely, the invention relates to an integrated optics component including at least one optical guide core and at least one optical cladding in a substrate, the core and the cladding being independent of each other in the substrate, at least one portion of the said cladding surrounding at least one portion of the said core so as to define at least one so-called interaction area between the core and the cladding, the refraction index of the cladding is different from the refraction index of the substrate and is less than the refraction index of the core at least in the part of the cladding close to the core and at least in the interaction area, a light wave possibly being introduced into the said area through the core and/or the cladding.

Obviously, the substrate can be made from a single material or by the superposition of several layers of material. If it is made from several layers of material, the refraction index of the cladding is different from the refraction index of the substrate, at least in layers close to the cladding.

According to one preferred embodiment, the cladding and the cores are made from the substrate, by a modification of the refraction index of the substrate and not by transfer of layers as in prior art.

According to the invention, the guide may be a plane guide when light is confined in a plane containing the direction of propagation of light or a microguide, when light is confined in two directions transverse to the direction of propagation of light.

The guide core and the cladding are independent of each other, in other words they can exist in the substrate independently of each other.

Also, in one advantageous embodiment of the invention, the cladding only surrounds one portion of the guide core. Thus, the cladding acts on propagation of a light wave in the guide core in the interaction area only, and the cladding can guide or transport light waves independently of the core.

Since the cladding is independent from the core, the parameters of the cladding and the core can easily be adapted to the required applications. Thus, it is easy to vary the dimensions, the value of the refraction index and the position of the cladding with respect to the dimensions and the value of the refraction index of the guide core. Thus, at least one characteristic of the mode(s) propagating in the guide core and/or of one or more propagation modes in the cladding can be modified.

Advantageously, the cladding has a refraction index greater than the refraction index of the substrate, so that cladding propagation modes can be induced.

Furthermore, according to a first embodiment, the light wave is introduced into the cladding to induce these cladding modes. And according to a second embodiment that can be combined with the first, the interaction area comprises a grating formed in the guide core and/or in the cladding.

According to this second embodiment, when the light wave is introduced into the guide core, the guide mode is then coupled to one or several of the cladding modes in the interaction area, and conversely when the light wave is introduced into the cladding, the cladding mode(s) is (are) coupled to the guided mode of the core in the interaction area.

The grating may be periodic or pseudo-periodic, and may also be composed of a sequence of gratings.

Many integrated optics components may be made by combining one or several guide cores with one or several optical claddings so as to create several interaction areas, and each area may or may not comprise a grating.

Thus, it is possible to make a component comprising a guide core comprising a first and second ends, an optical cladding and an interaction area formed by a part of the cladding surrounding part of the core, in a substrate, the said area comprising a grating, a light wave being introduced into the core through one of the ends, and being recovered at the output from the core through the other end.

Advantageously, the two ends of the core are outside the interaction area, which enables better flexibility for introduction and/or recovery of the wave and better filtering when this component is used as a filter.

In particular, this component can be used to make an optical filter: guided mode of the light wave introduced into the core is coupled in the interaction area through the grating to one or several cladding modes for wavelengths λⱼ defined in relation (1). The coupled part of the light wave in cladding modes may or may not be recovered at the output from the cladding, and the uncoupled part of the wave, in other words the filtered light wave for wavelengths λⱼ, is recovered at the output from the core.

Similarly, components according to the invention without a grating can be made.

In particular, the component of the invention may be an interferometer and comprises at least two guide cores with a first and a second end, the first ends being connected to each other through a first Y junction and the second ends being connected to each other through a second Y junction, this component also comprising at least one cladding surrounding at least one portion of one of the cores.

Advantageously, the substrate is made of glass.

Obviously, the substrate may also be made of other materials for example crystalline materials of the KTP or LiNbO₃ or LiTaO₃ type.

Furthermore, the optical cladding and/or the guide core and/or the grating may be made using any type of technique that can be used to modify the refraction index of the substrate. In particular, there are ion exchange, ionic implantation and/or radiation techniques, for example by laser insulation or laser photo writing.

More generally, the grating may be made by any technique that can modify the effective index of the substrate. Therefore, in addition to the techniques mentioned above, in particular it is possible to add techniques for making gratings by etching the substrate close to the interaction area. This etching may be done above the interaction area or in the portion of the cladding in the interaction area and/or possibly in the core portion of the interaction area.

The grating pattern may be obtained either by laser scanning if radiation is used, or by a mask. The mask may be the mask used to obtain the core and/or the cladding or a special mask for making the grating.

The invention also relates to a method of making an integrated optics component including at least one optical guide core and at least one optical cladding in a substrate, the core and the cladding being independent of each other in the substrate, at least one portion of the said cladding surrounding at least one portion of at least one core so as to define at least one so-called interaction area between the core and the cladding, the core and the cladding being made by modifying the refraction index of the substrate such that the refraction index of the cladding is different from the refraction index of the substrate and is less than the refraction index of the core, at least in the part of the cladding close to the core and at least in the interaction area.

The refraction index of the substrate is modified particularly by radiation, for example by laser insolation or by laser photo writing and/or by introduction of ionic species.

According to one preferred embodiment, the method according to the invention includes the following steps:
a) introduction of a first ionic species into the substrate so as to obtain the optical cladding after step c),
b) introduction of a second ionic species into the substrate so as to obtain the guide core after step c),
c) burial of ions introduced in steps a) and b), so as to obtain the cladding and the guide core.

Obviously the order of steps a) and b) could be reversed.

The first and/or second ionic species is advantageously introduced by ion exchange, or by ionic implantation.

The first and second ionic species may be the same or they may be different.

The first ionic species and/or the second ionic species may be introduced with application of an electric field.

In the case of an ion exchange, the substrate must contain ionic species that can be exchanged.

According to one preferred embodiment, the substrate is made of glass and contains previously introduced Na+ ions, and the first and second ionic species are Ag+ and/or K+ ions.

According to a first embodiment, step a) includes production of a first mask comprising a pattern that is suitable for producing the cladding, the first ionic species being introduced through this first mask, and step b) includes elimination of the first mask and production of a second mask containing a pattern suitable for producing the core, the second ionic species being introduced through this second mask.

According to a second embodiment, step a) includes the production of a mask comprising a pattern that can be used to obtain the cladding and the core, the first and second ionic species in steps a) and b) being introduced through this mask.

The masks used in the invention may for example be made of aluminium, chromium, alumina or a dielectric material.

According to a first embodiment of step c), the first ionic species is buried at least partially before step b) and the second ionic species is buried at least partially after step b).

According to a second embodiment of step c), the first ionic species and the second ionic species are buried simultaneously after step b).

According to a third embodiment of step c), burial includes a deposition of at least one layer of material with refraction index advantageously less than the refraction index of the cladding, on the surface of the substrate.

Obviously, this embodiment may be combined with the previous two embodiments.

Advantageously, at least part of the burial is done including the application of an electric field.

In general, before burial under a field and/or deposition of a layer, the method according to the invention may also comprise burial by rediffusion in an ionic bath.

This rediffusion step may be done partly before step b) to rediffuse ions in the first ionic species and partly after step b) to rediffuse ions in the first and in the second ionic species. This rediffusion step may also be done entirely after step b), to rediffuse ions in the first and second ionic species.

For example, this rediffusion is obtained by dipping the substrate in a bath containing the same ionic species as that previously contained in the substrate.

Other characteristics and advantages of the invention will become clearer after reading the following description given with reference to the appended figures. This description is given purely for illustrative and non-limitative purposes.

### BRIEF DESCRIPTION OF THE FIGURES

FIGS. 1 and 2, already described, diagrammatically show a perspective and sectional view of an optical cladding associated with a grating made in the core of an optical fibre,

FIG. 3, diagrammatically shows a perspective view of an example embodiment of an optical cladding according to the invention associated with a grating made in the core of an optical guide,

FIG. 4 diagrammatically shows the example in FIG. 3 in a sectional view,

FIG. 5 diagrammatically shows an example of a profile with refraction index n obtained in an interaction area according to the invention,

FIG. 6 diagrammatically illustrates a sectional view through a first example application of the component according to the invention, to form a filter,

FIGS. 7a and 7b diagrammatically illustrate a perspective view and a sectional view respectively through a second example application of the component according to the invention, to form interferometer,

FIGS. 8a to 8d diagrammatically illustrate a sectional view through an example method of making a component according to the invention,

FIGS. 9a to 9d diagrammatically illustrate variant embodiments of a mask pattern for obtaining a grating in the core, and

FIG. 10 shows a sectional view through a variant embodiment of the component according to the invention, with a grating in the cladding.

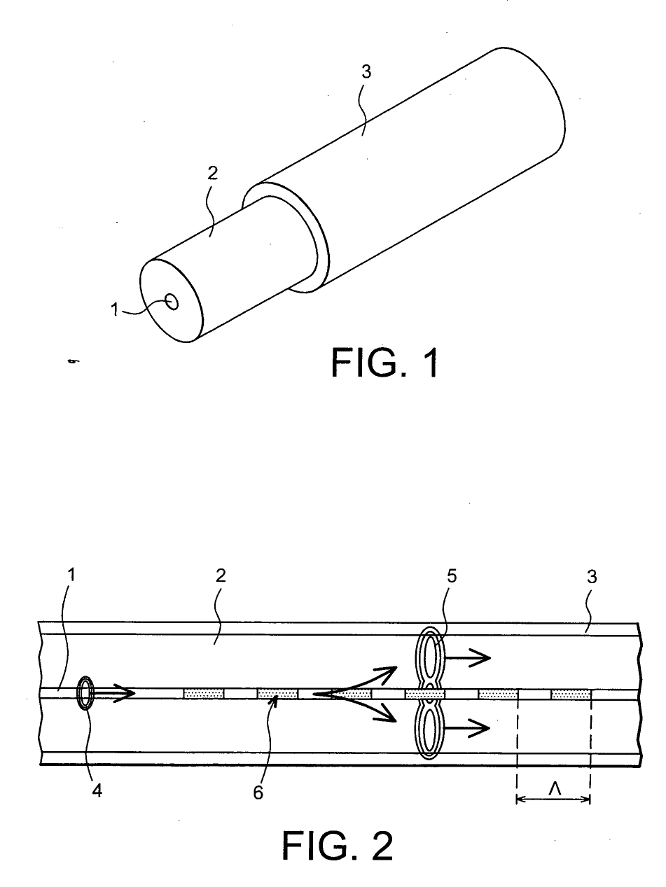

### DETAILED DESCRIPTION OF EMBODIMENTS OF THE INVENTION

To simplify the description of all these figures, the guide cores and claddings have been shown at a constant burial depth in the substrate, although it is quite obvious that the cores and the claddings may be buried at a variable depth, depending on target applications. Claddings with a constant refraction index are described for simplification reasons, but obviously it would be quite possible to use claddings with a variable index within the scope of this invention, provided that their indexes close to the core are smaller than the refraction index of the core.

Similarly, although the substrate may include one layer or several layers, all these figures represent a substrate with a single layer.

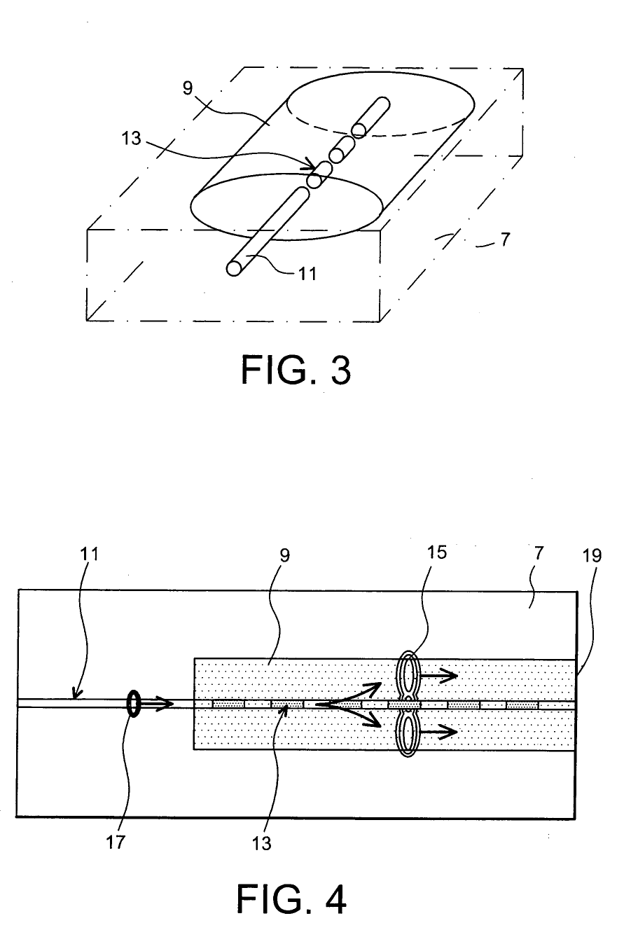

FIGS. 3 and 4 show a perspective view and a sectional view respectively of an example embodiment in integrated optics, of an optical cladding 9 associated with a grating 13, made in the core 11 of an optical guide in a substrate 7. The section through FIG. 4 is made in a plane parallel to the surface of the substrate and containing the core 11.

In this Figure, the optical cladding 9 only surrounds the portion of the core 11 that includes the grating 13. The area of the substrate that includes the cladding and the guide core is called an interaction area.

It is quite clear in these figures that the core 11 exists independently of the cladding 9 since outside the interaction area, the core is no longer located in the cladding, but only in the substrate 7 that enables optical isolation of the core.

The cladding is thus created artificially in the substrate, at least around a portion of the core comprising the grating and independently of the core and the substrate.

In general, an artificial cladding refers to this type of cladding made according to the invention, and a grating with artificial cladding when the interaction area comprises a grating.

In this example embodiment, the cladding is made in the substrate so as to have a refraction index between the refraction index of the substrate and the refraction index of the guide core, so that it is possible to have cladding modes due to the presence of the grating 13 (reference 15 in FIG. 4).

The grating 13 made in the core 11 in the interaction area is a sequence of periodic or pseudo-periodic patterns formed in this example by segmentation of the core 11.

Thus, when guided mode reference 17 of the light wave that propagates in the core 11 arrives in the interaction area defined by the part of the substrate that comprises the cladding 9 and the core 11 in this case provided with the grating 13, guided mode 17 will be coupled to one or several cladding modes 15.

It would also have been possible to introduce the light wave into the cladding 15 directly, the cladding mode(s) would then have been coupled to the guided mode of the core through the grating. To enable this introduction, the cladding is made such that one of its ends (reference 19) is located for example on a sidewall of the substrate.

Since the cladding is independent from the guide core, it is possible to adapt cladding parameters (such as dimensions, the index and the position) to suit core parameters (such as the dimensions, the index and the position) to target applications.

The coupling force between a guided mode and a given cladding mode, is obtained by taking the product of the grating length and the coupling coefficient κ. This coupling coefficient is proportional to the overlap integral of the two coupled modes, weighted by the grating profile.

We will denote the transverse profiles of guided and cladding modes as ξ₀ and ξⱼ respectively and the grating profile Δn, the coupling coefficient κ is then given by a relation of the following type:
κ∝∫∫ξ₀,ξⱼ*.Δn.ds (2)
where ds is an integration element over the entire transverse surface of the substrate, in other words in a plane perpendicular to the propagation axis of the wave.

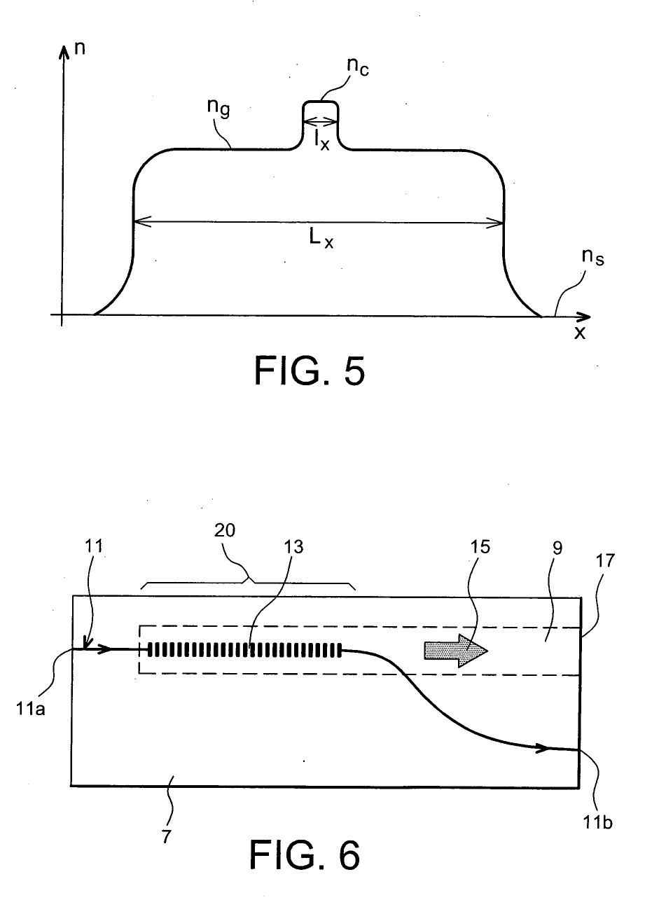

FIG. 5 shows an example of a profile with refraction index n obtained in the interaction area along a direction x transverse to the direction of propagation of a light wave in the core. The dimension Lₓ along this direction of the cladding with index n_{g} and dimension lₓ along this same direction of the core with index n_{c}, can be seen clearly on this profile. The index nₛ of the substrate has been used as a reference. Obviously, other index profiles can be obtained by varying the parameters of the cladding and the core depending on the target applications.

Thus, as the dimensions and index at the cladding increase, the number of cladding modes that could propagate will increase and therefore the number of possible filter bands in the filter application will increase. This may be an advantage if multiple filters are required or if a margin is required in the choice of a filter mode.

Conversely, if it is required to limit the number of cladding modes that can be coupled, it is useful to reduce the opto-geometric dimensions of the cladding.

For other interferometer type applications, the choice of the index of the cladding is important too since it provides a means of modifying the index difference that will be defined in relation (3) below.

The dimensions and index of the guide core affect the characteristics of the mode that propagates in it, and for example enable it to adapt to a fibre mode in the case of coupling between the guide core and the fibre core.

Furthermore, as the differences between the indexes of the core, the cladding and the substrate increase, the possibility of having couplings for short grating periods also increases, as shown by relation (1) (at a given resonance wavelength, the period is inversely proportional to the difference in index between guided and cladding modes).

Application fields for components comprising an optical cladding surrounding a grating formed in the core of a guide are the same as application fields for the optical fibres containing gratings. In particular, it is worth mentioning applications such as loss filters with adapted spectrum (for example linear filtering) or sensor applications. Furthermore, making the cladding independent from the core makes many other applications possible, which would not be possible with concepts according to prior art.

Grating dimensions may also be adapted to target applications. Thus, it is possible to use gratings with long periods (for example a few tens of μm to several thousand μm) and gratings with shorter periods (for example less than a few μm) such as blazed gratings or gratings with inclined lines.

For example, FIG. 6 illustrates a section through a first example application of a component according to the invention to form a filter.

Thus, FIG. 6 shows an integrated optics component comprising a guide core 11, a cladding 9 surrounding the core 11 in an interaction area 20 comprising a grating 13 made in the core, in a substrate 7. In this example embodiment, the guide core penetrates into the cladding through one end of it at the interaction area and comes out of it after the interaction area, by curvature of the cure. The core is thus separated from the cladding outside the interaction area and the cladding remains present in the substrate without the guide core.

Part of the signal guided in the core is coupled to cladding modes 15 or vice versa, at the grating 13 in the interaction area.

Thus, when a light wave is introduced into the component through the end 11a of the core 11, the guided mode of the core is then coupled in the interaction area through the grating 13 to the grating mode(s) for one or more filter bands defined spectrally by relation (1). The part of the wave coupled to the cladding mode(s) at the output from the interaction area is propagated in the cladding while the remainder of the initial wave is transferred in the core 11 and can be recovered through the end 11b of the core.

It would also have been possible to allow for operation in the reverse direction. A light wave would then be introduced into the cladding at the end 17 of the cladding that does not include the core. At the passage into the interaction area 20, the spectral part of the wave that corresponds to the filter band(s) of the grating 13, is coupled in the guide core 11 and it can be extracted from the component through the end 11a of the core.

As described above, making an optical cladding that locally surrounds a portion of the guide core may be useful for many applications other than coupling through a grating.

The use of an optical cladding according to the invention can modify the characteristics of the mode propagating in the core.

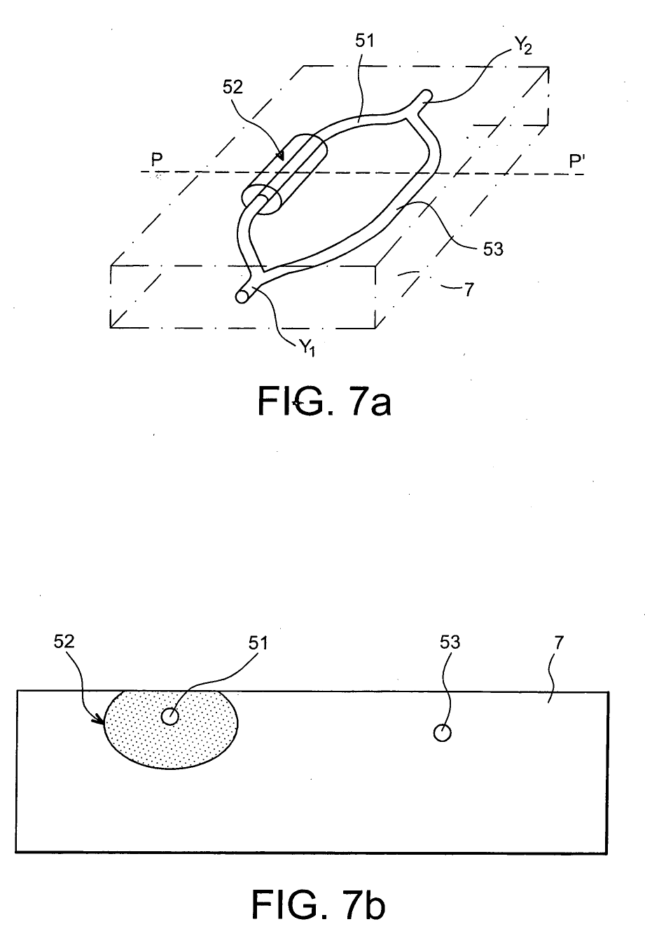

For example, FIGS. 7a and 7b illustrate a perspective and sectional view in a plane perpendicular to the surface of the substrate and containing the interaction area, through a second example application of the component according to the invention to form a Mach-Zehnder type interferometer, this component not containing any grating in the interaction area.

This interferometer comprises a guide core 51 in the substrate 7 with a guide core 53, the ends of which are connected to junctions Y, reference Y₁ and Y₂ respectively, thus forming two arms.

One cladding 52 surrounds a portion of the core 51 and thus creates an interaction area.

Therefore a light wave introduced into the interferometer, for example through the junction Y₁, is distributed in the two arms of the interferometer and then recombines at the output in junction Y₂. The phase shift Δφ accumulated between the two arms determines the signal level obtained at the output from the component.

If there is no cladding 52, the interferometer is balanced and Δφ=0.

It the cladding 52 is present, the phase shift Δφ at wavelength λ is expressed as follows:

$$Δϕ = \frac{2 π}{λ} ( {n}_{eff1} - {n}_{eff2} ) \times L \qquad ( 3 )$$

n_{eff1} is the effective index of guided mode in the core-substrate area and n_{eff2} is the effective index of guided mode in the core-cladding area and L is the length of the interaction area that in this example is the length of the cladding. The difference (n_{eff1}−n_{eff2}) may be equal to values of up to a few 10^{-2.}

Conventionally, those skilled in the art would vary the length of the cores to make a non-zero phase shift. According to the invention, the use of a cladding provides a means of making a non-zero phase shift between the two cores, these two cores possibly being the same length, which simplifies production of the component. In particular, a single core mask can cover an entire range of components, possibly with different phase shifts since these phase shifts are adjusted using the cladding parameters only.

There are many possible applications of this interferometer, and in particular it can be used to make spectral references (measurements of the pitch between fringes) or attenuators at some wavelengths (filter).

It can also be used to make temperature sensors.

In relation 3, the difference (n_{eff1}−n_{eff2}) between the effective propagation indexes of guided mode with or without cladding depends particularly on the temperature, such that the phase shift at the output from the component is also a function of the temperature.

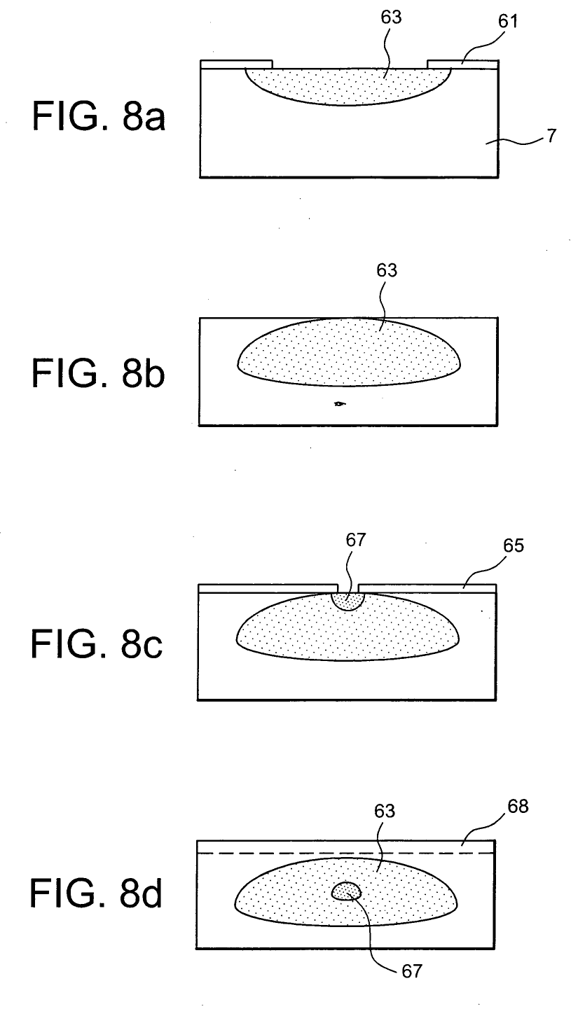

FIGS. 8a to 8b show sections in a plane perpendicular to the surface of the substrate and containing the interaction area, for an example method of making a component according to the invention, starting from the ion exchange technology.

Thus, FIG. 8a shows a substrate 7 containing ions B.

A first mask 61 is made, for example by photolithography on one of the faces of the substrate; this mask comprises an opening determined as a function of the dimensions (width, length) of the cladding that is to be obtained.

A first ion exchange is then made between A ions and B ions contained in the substrate, in a substrate area located close to the opening of mask 61. This exchange is obtained for example by dipping the substrate with the mask into a bath containing A ions and possibly applying an electric field between the face of the substrate on which the mask is located and the opposite face. The substrate area in which this ion exchange took place forms the cladding 63.

This cladding is buried by carrying out a rediffusion step for A ions with or without the assistance of an electrical field applied as above. FIG. 8b shows the cladding after a partial burial step of the cladding. The mask 61 is usually removed before this step.

Therefore, the production of the cladding according to the invention is similar to the production of a guide core, but the dimensions are different.

The next step shown in FIG. 8c consists of forming a new mask 65 on the substrate, for example by photolithography, possibly after cleaning the face of the substrate on which it is made. This mask comprises patterns used to make a guide core 67 and particularly when a grating is made in the core, the patterns of the mask 65 can be adapted to the patterns of the grating to be formed.

A second ion exchange is then made between the B ions of the substrate and the C ions that may be the same as or different from the A ions. This ion exchange may be made as above by dipping the substrate in a bath containing C ions and possibly applying an electric field.

Finally, FIG. 8d illustrates the component obtained after burial of the core 67 obtained by rediffusion of ions C and final burial of the cladding, with or without the assistance of an electric field. The mask 65 is usually eliminated before this burial step.

Conditions for the first and second ion exchanges are defined so as to obtain the required differences in refraction indexes between the substrate, the cladding and the core. The adjustment parameters of these differences are particularly the exchange time, the bath temperature, the ion concentration in the bath and whether or not there is an electric field.

As an example embodiment, the substrate 7 is made of glass containing Na+ ions, the mask 61 is made of aluminium and has an opening about 30 μm wide (the length of the opening depends on the required cladding length for the target application).

The first ion exchange is made with a bath containing Ag+ ions at a concentration of approximately 20%, a temperature of about 330° C. and for an exchange time of about 5 minutes. Rediffusion of ions takes place firstly in air at a temperature of about 330° C. for 30 s, then the cladding thus formed is partially buried in the glass. This burial is done by rediffusion in a sodium bath at a temperature of about 260° C. for 3 minutes.

The mask 65 is also made of aluminium and has an opening pattern approximately about 3 μm wide (the pattern length depends on the required core length for the target application).

The second ion exchange is made with a bath also comprising Ag+ ions at a concentration of about 20%, a temperature of about 330° C. and for an exchange time of about 5 minutes, rediffusion of ions firstly in air at a temperature of about 330° C. and for 30 s. The core thus formed is then partially buried in the glass by rediffusion in a sodium bath at a temperature of about 260° C. for 3 minutes.

Final burial of the cladding and the core is made under an electric field, with the two opposite faces of the substrate in contact with two baths (in this example sodium), so that a potential difference between these two baths can be applied.

Many variants of the method described above can be produced. In particular, burial steps of the cladding and the core may be performed as described above during two successive steps, but they may also be done simultaneously because the core gets buried faster than the cladding because it has a higher ionic concentration than the cladding, and this also enables centring of the core in the cladding.

The difference in concentration between the core and the cladding is usually obtained by rediffusion of ions forming the cladding in a bath, or by a difference in the concentration of ions introduced in steps a) and b).

Furthermore, instead of using one mask to make the cladding and one mask to make the guide core, a single mask can be used if the core and the cladding have the same length.

This can be done by making a mask, for example by photolithography on the substrate, this mask having the pattern of the core to be made with or without grating depending on the target application.

The first ion exchange is made to form the cladding, then a second ion exchange is made to form the core and the core and cladding are buried.

In one example of this embodiment for a glass substrate 7 containing Na⁺ ions, the single mask is made of aluminium and has an opening pattern about 3 μm wide (the pattern length depends on the required length of the cladding and the core).

The first ion exchange is made with a bath containing Ag⁺ ions with a low concentration of about 1%, at a temperature of about 330° C. and for an exchange time of about 20 minutes with application of an electric field. Rediffusion of ions in glass takes place in air at a temperature of 330° C. for 30 s.

The second ion exchange is made with a bath also containing Ag⁺ ions with a concentration of about 20%, at a temperature of about 330° C. and for an exchange time of about 8 minutes. Rediffusion of ions in glass takes place in air at a temperature of 330° C. for 30 s.

Finally, the core and the cladding are buried firstly by rediffusion in a sodium bath at a temperature of about 260° C. and for 3 minutes, then by application of an electric field between the two opposite faces of the substrate.

As we have already seen, one variant of the method of burying the cladding and the core consists of depositing a layer of material 68, shown in dashed lines in FIG. 8d, on the substrate 7. To enable optical guidance, this material must advantageously have a refraction index less than the refraction index of the cladding.

The component according to the invention is produced not only using the ion exchange technique. The component according to the invention may obviously be made using any technique that can be used to modify the refraction index of the substrate.

If used in the interaction area of a grating, the period, size and position of the grating with respect to the core and the cladding are parameters that may be adapted as a function of the applications.

The grating pattern may be defined on the mask to produce the cladding and/or the mask to produce the core, or on the single mask to produce the cladding and the core at the same time, or on a specific mask to produce the grating only.

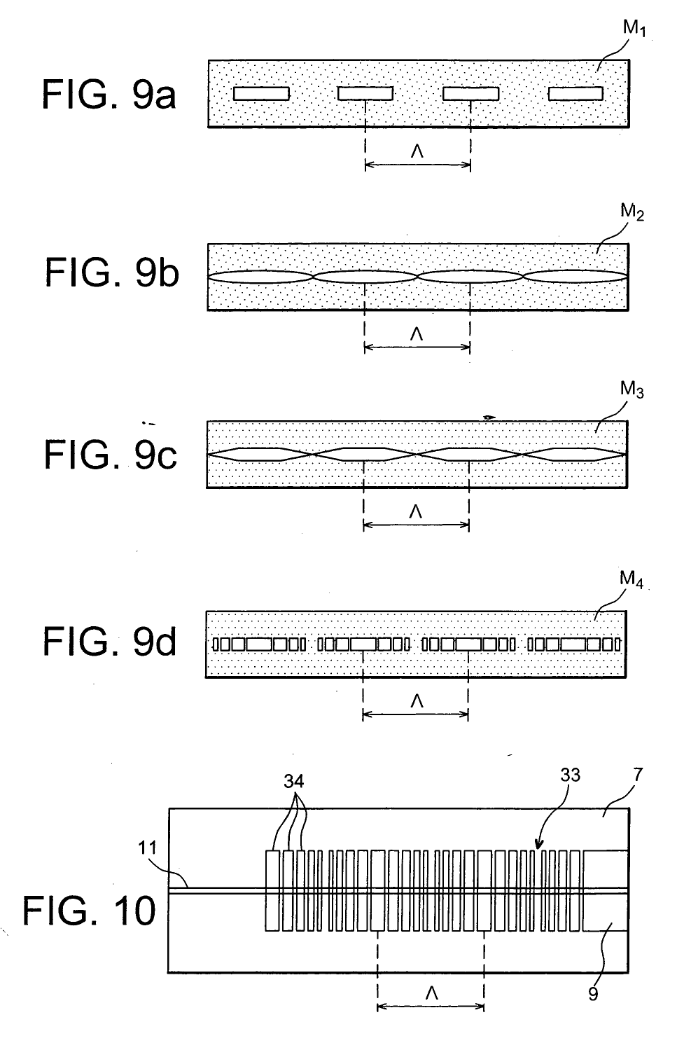

FIGS. 9a to 9d illustrate examples of variant embodiments of masks M₁, M₂, M₃, M₄ used to obtain a grating. These Figures show top views of masks and only show the part of the masks used to obtain the grating. White areas in the pattern of masks correspond to openings in the masks.

These masks can be used to obtain a periodic grating with period Λ.

For example, these masks may be specific masks to produce the grating in the core and/or in the cladding, or part of the masks that can be used to obtain the core and/or the cladding, the grating then being made at the same time as the core and/or the cladding.

FIG. 4 described above illustrates an example grating formed in the guide core.

FIG. 10 illustrates an example embodiment of a grating 33 made in an interaction area common to the core 11 and the cladding 9.

Thus, in FIG. 10, the grating 33 is formed in the cladding 9 by an alternation with period Λ of areas 34 with variable width considered in the direction of propagation of a light wave. These areas have an effective index different from the effective index of the rest of the cladding due to a change in the refraction index in these areas. Moreover, the core is included in the cladding at least in the interaction area, the grating is also inscribed in the core, in other words the core also comprises areas with refraction indexes different from the refraction index of the rest of the core.

The gratings may be formed by any conventional technique for locally modifying the effective index of the substrate in the core and/or in the cladding.

Therefore, it can be done, during ion exchanges used to make the core and/or the cladding or during a specific ion exchange. But, it may also be done by etching the substrate at the interaction area or by radiation. In particular, the grating may be obtained by insolation of the core and/or the cladding with a CO₂ type laser. The laser can locally rediffuse ions by creating local temperature rises, and thus inscribe the grating pattern.

For example, the substrate can be scanned with a laser beam, for example an amplitude modulated laser beam, so as to introduce a modulation of the grating at the required pitch.

The grating pattern depends on target applications. In particular, the grating may have a variable period (chirped grating), or variable efficiency (apodised grating).

1. An integrated optical component comprising:
an optical guide core and an optical cladding in a substrate, the optical guide core and the optical cladding being independent of each other in the substrate, at least one of said optical guide core and/or said optical cladding being configured to receive a light wave,
wherein at least a portion of said optical cladding surrounds at least a portion of said optical guide core so as to define at least an interaction area between the optical guide core and the optical cladding,
wherein a refractive index of the optical cladding is different from a refractive index of the substrate and the refractive index of the optical cladding is less than a refractive index of the optical guide core at least in a part of the optical cladding close to the optical guide core and at least in the interaction area.

2. An integrated optical component according to claim 1, wherein the refractive index of the optical cladding is greater than the refractive index of the substrate.

3. An integrated optical component according to claim 1, wherein the interaction area comprises a grating formed in the optical guide core and/or in the optical cladding.

4. An integrated optical component according to claim 3, wherein the optical a guide core comprises first and second ends, and the interaction area comprises a grating, wherein said first end of the optical guide core is adapted to receive a light wave and said second end of the optical guide core is adapted to output the light wave.

5. An integrated optical component according to claim 4, wherein the first and second ends of the optical guide core are outside the interaction area.

6. An integrated optical component comprising:
a first optical guide core formed in a substrate, the first optical guide core having a first end and a second end:
a second optical guide core formed in the substrate, the second optical guide core having a first end and a second end; and
an optical cladding formed in the substrate and surrounding at least a portion of at least one of the first optical guide core and/or the second optical guide core,
wherein the first end of the first optical guide core and the first end of the second optical guide core are connected through a first junction and the second end of the first optical guide core and the second end of the second optical guide core are connected through a second junction.

7. A method of manufacturing an integrated optical component, comprising:
forming an optical guide core in a substrate;
forming an optical cladding in the substrate around at least a portion of the optical guide core so as to define an interaction area between the optical guide core and the optical cladding; and
modifying a refractive index of the substrate such that a refractive index of the optical cladding is different from the refractive index of the substrate and such that the refractive index of the cladding is less than a refractive index of the optical guide core at least in a part of the optical cladding adjacent to the optical guide core and in the interaction area.

8. A method of manufacturing according to claim 7, wherein modifying the refractive index of the substrate comprises irradiating the substrate and/or introducing ionic species into the substrate.

9. A method of manufacturing according to claim 8, wherein introducing ionic species into the substrate comprises:
introducing a first ionic species into the substrate to form the optical cladding,
introducing a second ionic species into the substrate to form the optical guide core, and
burying the first and second ionic species so as to obtain the optical cladding and the optical guide core.

10. A method of manufacturing according to claim 9, wherein introducing the first and second ionic species into the substrate includes introducing the first and/or the second ionic species by ion exchange and/or by ionic implantation.

11. A method of manufacturing according to claim 10, wherein the substrate comprises of glass and Na+ ions, and the first and second ionic species are selected from the group comprising Ag+ ions and K+ ions.

12. A method of manufacturing according to claim 9, wherein
introducing a first ionic species into the substrate to form the optical cladding includes producing a first mask comprising a pattern that is suitable for producing the optical cladding, and introducing the first ionic species through said first mask, and
introducing a second ionic species into the substrate to form the optical guide core includes eliminating the first mask and producing a second mask containing a pattern suitable for producing the optical guide core, and introducing the second ionic species through said second mask.

13. A method of manufacturing according to claim 9, wherein introducing a first ionic species into the substrate to form the optical cladding includes producing a mask comprising a pattern configured to obtain the optical cladding and the optical guide core, and introducing the first and second ionic species through said mask.

14. A method of manufacturing according to claim 7, further comprising forming a grating in the interaction area by modifying an effective index of the substrate in the optical cladding and/or in the optical guide core according to a selected pattern.

15. A method of manufacturing according to claim 14, wherein said modifying an effective index of the substrate in the optical cladding and/or in the optical guide core includes introducing ionic species through a mask for producing the optical guide core and/or the optical cladding or through a another mask.

16. A method of manufacturing according to claim 14, wherein the selected pattern of the grating is obtained by creating local temperature rises.

17. A method of manufacturing according to claim 14, wherein the selected pattern of the grating is obtained by etching the substrate close to in the vicinity of the interaction area.

18. A method of manufacturing according to claim 9, wherein the first ionic species is buried at least partially before introducing the second ionic species into the substrate, and the first and second ionic species are buried after introducing the second ionic species into the substrate.

19. A method of manufacturing according to claim 9, wherein the first ionic species and the second ionic species are buried after introducing the second ionic species into the substrate.

20. A method of manufacturing according to claim 9, wherein burying the first and/or the second ionic species comprises applying an electric field.

21. A method of manufacturing according to claim 9, wherein burying the first and/or the second ionic species comprises re-diffusing in an ionic bath.

22. A method of manufacturing according to claim 9, wherein burying the first and/or the second ionic species comprises depositing at least one layer of material on a surface of the substrate.

23. A method of manufacturing according to claim 9, wherein introducing the first ionic species and/or the second ionic species comprises applying an electric field.
